(19) United States
(12) Patent Application Publication
(10) Pub. No.: US 2015/0246710 A1
(43) Pub. Date: Sep. 3, 2015

(54) POWER MODULE OF ELECTRIC BICYCLE

(71) Applicant: Harmonic Innovation Technology Co., Ltd., TAIPEI CITY (TW)

(72) Inventor: Chun-Shen YEH, TAIPEI CITY (TW)

(21) Appl. No.: 14/480,291

(22) Filed: Sep. 8, 2014

(30) Foreign Application Priority Data
Mar. 3, 2014 (TW) 103107079

(51) Int. Cl. B62M 6/55; F16H 1/32

(52) U.S. Cl. CPC B62M 6/55; F16H 1/32; F16H 2001/327

(57) ABSTRACT

The invention provides a power module of an electric bicycle comprising a first power unit, a reduction unit, a second power unit, and a driving unit. The first power unit outputs a first horsepower with a first rotating speed and a first torque. The reduction unit decreases the first rotating speed to a second rotating speed, and the first torque is increased to a second torque. The reduction unit outputs a second horsepower. The second power unit outputs a third horsepower. The driving unit is coupled with the reduction unit and the second power unit for outputting either the second horsepower or the third horsepower. The power module has the advantages of low speed, high torque, small size, and low cost.

### CROSS-REFERENCE TO RELATED APPLICATIONS

This Non-provisional application claims priority under 35 U.S.C. §119(a) on Patent Application No(s). 103107079 filed in Taiwan, Republic of China Mar. 3, 2014, the entire contents of which are hereby incorporated by reference.

### FIELD OF THE INVENTION

The invention is related to the electric bicycle field. The electric bicycle uses a power module with a reducer in order to convert a high rotating speed and a low torque of a motor power into a low rotating speed and a high torque of a motor power. The electric bicycle also uses a driving unit to switch between motor power source and pedal power source.

### BACKGROUND OF THE INVENTION

Conventionally, the electric bicycle uses a front or a rear hub motor. However, the configurations of the traditional motors have many disadvantages. Firstly, the center of gravity will be located at the rear or at the front of the electric bicycle which reduces the balance of the bicycle and affect the stability while riding. Secondly, the electric bicycle with a front hub motor or a rear hub motor will increase maintenance difficulty. Thirdly, because the front hub motor directly outputs power to the front wheel and the rear hub motor directly outputs power to the rear wheel, the front hub motor or rear hub motor cannot work with the derailleur of the electric bicycle to shift speed.

In order to solve the above-mentioned disadvantages, it is better to change the position of the motor to the middle portion of the electric bicycle. A motor located in the middle portion of the bicycle is usually called mid-motor. The mid-motor can switch the center of gravity from the front or the rear to the middle portion of the bicycle. In order to meet the riding requirements, the mid-motor must have a low rotating speed and a high torque output capability. Thus, the mid-motor needs to be equipped with an additional planetary reducer with low reduction ratio to obtain the power source output with low rotating speed and high torque.

Because the reduction ratio of the planetary reducer is low, the planetary reducer cannot significantly reduce the rotating speed of the mid-motor and cannot significantly increase the torque of the mid-motor. Therefore, a motor with second level of reducer is also needed to provide the power source which outputs low rotating speed and high torque. However, two levels of reducer gears within a motor have the disadvantages of large size, heavy weight and high cost.

As a result, the present invention provides an electric bicycle power module to solve the problems of conventional techniques.

### SUMMARY OF THE INVENTION

The first purpose of the present invention is to provide a power module for an electric bicycle. The power module comprises one level reducer with a high reduction ratio which can convert a high rotating speed and a low torque of a motor power into a low rotating speed and a high torque of a motor power; therefore, the power module of an electric bicycle has the advantages of low speed, high torque, small size, light weight and low cost.

The second purpose of the present invention is to produce a mid-motor with small size and high torque based on the above-mentioned power module of an electric bicycle. The mid-motor not only can stabilize the center of gravity of the electric bicycle, but also is easy to maintain the front or rear wheel of the electric bicycle. Moreover, it is easy to work with the derailleur of the electric bicycle to shift speed.

The third purpose of the present invention is to produce a reducer composed of an eccentric shaft, a bearing, a circular gear with external teeth, a ring gear with internal teeth and a constraint plate. The reducer achieves high reduction ratio by adjusting the circular gear with external teeth number and the ring gear with internal teeth number.

The fourth purpose of the present invention is to form multiple one-way bearings composed of multiple ring-shaped bodies and a flange based on the above-mentioned power module of an electric bicycle. These one-way bearings can receive the motor power source from the reducer and pedal power source.

In order to achieve the above purposes, the present invention provides a power module of an electric bicycle. The power module of an electric bicycle comprises a first power unit, a reduction unit, a second power unit, and a driving unit. The first power unit provides a first rotating speed and a first torque. The first power unit outputs the first horsepower which is the product of the first rotating speed and the first torque. The reduction unit is coupled with the first power unit. The reduction unit decreases the first rotating speed to a second rotating speed, increases the first torque to a second torque, and outputs a second horsepower which is the product of the second rotating speed and the second torque. The second power unit outputs a third horsepower. The driving unit is coupled with the reduction unit and the second power unit to output the second horsepower or the third horsepower.

Compared with conventional technology, the power module of an electric bicycle in the invention can convert a high rotating speed and a low torque of a motor power (with advantages of low cost and small size) into a low rotating speed and a high torque of a motor power. The small sized power module can be positioned in the middle portion of the electric bicycle, and therefore, solves the problems of the conventional technology.

Besides, the power module of an electric bicycle can receive multiple power sources, such as a motor power source or a pedal power source. Moreover, the power module can shift between the two power sources automatically to drive the electric bicycle without any manual switch.

### BRIEF DESCRIPTION OF THE DRAWINGS

FIG. 1 shows an exploded view of the power module of an electric bicycle in the invention.

FIG. 2 is a detailed structure diagram of the reduction unit components.

FIG. 3 shows a detailed structure diagram of driving unit in FIG. 1.

### DETAILED DESCRIPTION OF THE INVENTION

For clarity of disclosure, the detailed description of the invention follows.

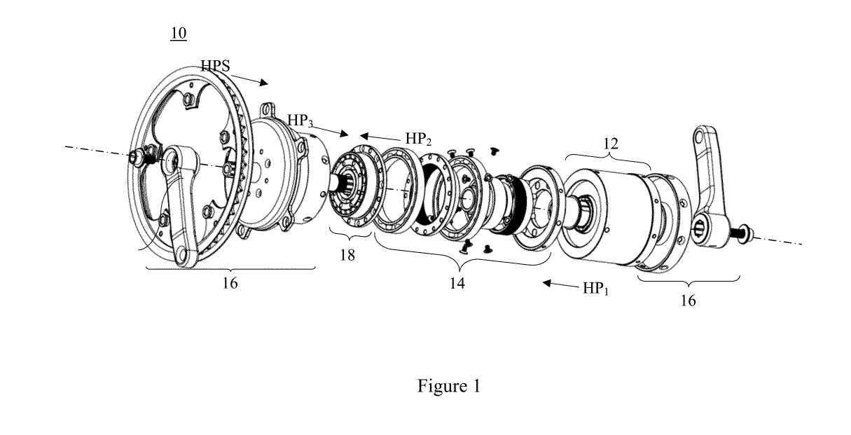

The FIG. 1 shows an exploded view of the power module of an electric bicycle in the invention. As shown in FIG. 1, the power module 10 of an electric bicycle comprises a first power unit 12, a reduction unit 14, a second power unit 16, and a driving unit 18.

The first power unit 12 provides a first rotating speed and a first torque and the first power unit 12 is an electric device, such as a motor. A high rotating speed and a low torque are taken as an example. The first power unit 12 outputs a first horsepower HP₁. The definition of the first horsepower HP₁ is the product of the first rotating speed and the first torque.

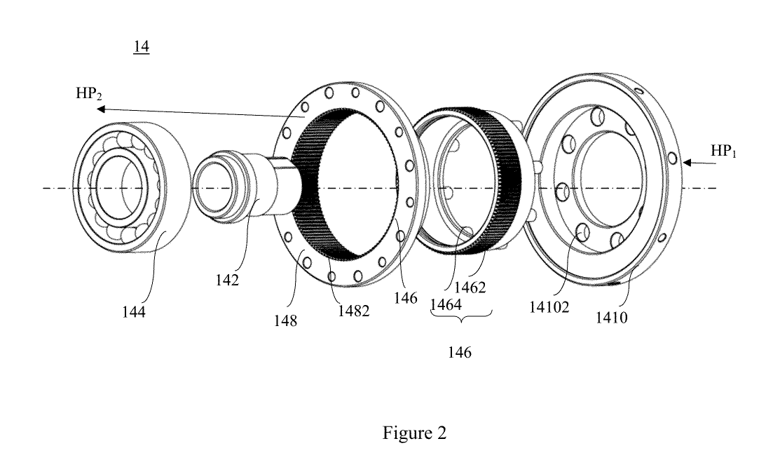

The reduction unit 14 is coupled with the first power unit 12 to receive first horsepower HP₁ from the first power unit 12. The reduction unit 14 decreases the first rotating speed to a second rotating speed and increases the first torque to a second torque. The reduction unit 14 outputs a second horsepower HP₂. It should be noted that the second torque is larger than the first torque. The components of the reduction unit 14 are shown is a detailed structure diagram, FIG. 2.

In FIG. 2, the reduction unit 14 comprises an eccentric shaft 142, a bearing 144, a circular gear with external teeth 146, a ring gear with internal teeth 148 and a constraint plate 1410. The eccentric shaft 142 is combined with the bearing 144 to pass through the circular gear with external teeth 146. The circular gear with external teeth 146 is connected to the constraint plate 1410 and is partially engaged with the ring gear with internal teeth 148.

In the static state, the center axis of the eccentric shaft hole 142 is coaxial with the center axis of the reduction unit 14. Because the wall thickness of the eccentric shaft 142 is asymmetric. The center axis of the eccentric shaft hole 142 is possibly not coaxial with the center axis of the reduction unit 14 during the moving state.

The circular gear with external teeth 146 has multiple first gear teeth 1462 on the outer side, and the number of the first gear teeth 1462 is the first number T1. The circular gear with external teeth 146 is partially engaged with the ring gear with internal teeth 148. Multiple constraint columns 1464 are on the circular gear with external teeth 146 to connect to the constraint plate 1410.

The ring gear with internal teeth 148 has multiple second gear teeth 1482 on the inner side, and the number of the second gear teeth 1482 is a second number T2.

The constraint plate 1410 has multiple round holes 14102. The diameters of the round holes are larger than the diameters of the constraint columns 1464.

The operation principle of the reduction unit 14: when the eccentric shaft 142 rotates, the eccentric shaft 142 drives the circular gear with external teeth 146 via bearing 144. Because the wall thickness of the eccentric shaft 142 is asymmetric, when the circular gear with external teeth 146 rotates, the axis of the circular gear with external teeth 146 is not fixed. Moreover, the circular gear with external teeth 146 does not rotate with the eccentric shaft 142 which means that the circular gear with external teeth 146 does not rotate with its own axis. The circular gear with external teeth 146 is limited to slight movement in the round holes 14102 with the constraint columns 1464. During the movement, a portion of the first gear teeth 1462 of the circular gear with external teeth 146 is continuously engaged with a portion of the second gear teeth 1482 of the ring gear with internal teeth 148. The first number T1 of the first gear teeth 1462 is different from the second number T2 of the second gear teeth 1482; therefore, cause the ring gear with internal teeth 148 to rotate slowly.

The definition of the reduction ratio RR of the reduction unit 14 is the ratio of the second number T2 to a teeth difference D. The teeth difference D exists between the first number T1 and the second number T2. As a result, the mathematic expression of the reduction ratio RR follows:

RR=T2/D

It should be noted that the reduction ratio RR of the reduction unit 14 of the present invention is much higher than the reduction ratio of conventional planetary reducers.

The second power unit 16 outputs a third horsepower HP₃ with a third rotation speed. A bike rider is used as an example here. A rider can output human power source (HPS) by the pedaling force, which is not limited herein.

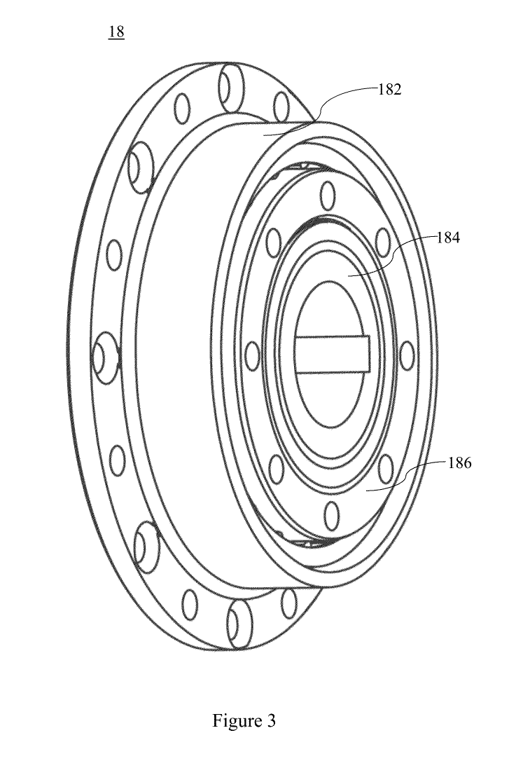

The driving unit 18 is coupled with the reduction unit 14 and the second power unit 16 to output the second horsepower HP₂ or the third horsepower HP₃. Please refer to FIG. 3 which shows a detailed structure diagram of the driving unit in FIG. 1. The driving unit 18 comprises a first ring-shaped body 182, a second ring-shaped body 184 and a flange 186.

The first ring-shaped body 182 and the second ring-shaped body 184 are both coupled with the flange 186. The first ring-shaped body 182 is connected to the flange 186 to form a first one-way bearing, and the second ring-shaped body 184 is connected to the flange 186 to form a second one-way bearing. The first one-way bearing outputs the second horsepower HP₂ or the second one-way bearing outputs the third horsepower HP_{3.} It should be noted that the first ring-shaped body 182 rotates with the second rotation speed, and the second ring-shaped body 184 rotates with the third rotation speed. The flange 186 is coupled by the first ring-shaped body 182 or the second ring-shaped body 184 according to the one with higher rotation speed between the second rotation speed and the third rotation speed. It means that the one with higher rotation speed between the first ring-shaped body 182 and the second ring-shaped body 184 can tow the flange 186 to output the second horsepower HP₂ or the third horsepower HP₃.

For example, the first rotating speed of the first power unit 12 is 3000 rpm (Revolution per Minute), the first torque of the first power unit 12 is 1 Nm (Newton-meter), and the reduction ratio RR of the reduction unit 14 is 30. When the first power unit 12 is connected to the reduction unit 14, the reduction unit 14 outputs a rotating speed of 100 rpm and a torque of 30 Nm. Compared with the original motor power of the first power unit 12, the power output decreases to 100 rpm (low rotating speed) from 1000 rpm (high rotating speed), and the torque increases to 30 Nm (high torque) from 1 Nm (low torque).

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A power module of an electric bicycle, comprising:
a first power unit, providing a first rotating speed and a first torque, the first power unit outputs a first horsepower which is a product of the first rotating speed and the first torque;
a reduction unit. coupled with the first power unit, the reduction unit decreases the first rotating speed to a second rotating speed, increases the first torque to a second torque, and outputs a second horsepower which is a product of the second rotating speed and the second torque;
a second power unit, outputting a third horsepower; and
a driving unit, coupled with the reduction unit and the second power unit, the driving unit outputs the second horsepower or the third horsepower.

2. The power module of an electric bicycle according to claim 1, wherein the reduction unit comprises an eccentric shaft, a bearing, a circular gear with external teeth, a ring gear with internal teeth and a constraint plate; the eccentric shaft is combined with the bearing to pass through the circular gear with external teeth connected to the constraint plate and partially engaged with the ring gear with internal teeth.

3. The power module of an electric bicycle according to claim 2, wherein the circular gear with external teeth has a first number of gear teeth, and the ring gear with internal teeth which has a second number of gear teeth; a teeth difference exists between the first number and the second number, and the ratio of the second number to the teeth difference is the reduction ratio.

4. The power module of an electric bicycle according to claim 1, wherein the driving unit comprises a first ring-shaped body, a second ring-shaped body and a flange; the first ring-shaped body and the second ring-shaped body are coupled with the flange to form a first one-way bearing and a second one-way bearing; the first ring-shaped body is connected to the reduction unit, and the second ring-shaped body is connected to the second power unit; the first ring-shaped body rotates with the second rotating speed, and the second ring-shaped body rotates with a third rotating speed; the flange is towed by the first ring-shaped body or the second ring-shaped body, whichever has the higher rotating speed, to output the second horsepower or the third horsepower.
